(19) United States
(12) Patent Application Publication
(10) Pub. No.: US 2006/0247906 A1
(43) Pub. Date: Nov. 2, 2006

(54) METHOD FOR ESTIMATING CLOCK JITTER FOR STATIC TIMING MEASUREMENTS OF MODELED CIRCUITS

(75) Inventors: John S. Austin, Winooski, VT (US); David J. Hathaway, Underhill, VT (US); Timothy M. Platt, Williston, VT (US); Stephen D. Wyatt, Jericho, VT (US)

Correspondence Address: CONNOLLY BOVE LODGE & HUTZ LLP;IBM MICROELECTRONICS DIVISION, 1990 M STREET NW, SUITE 800, WASHINGTON, DC, 20036-3425, US

(73) Assignee: INTERNATIONAL BUSINESS MACHINES CORPORATION, Armonk, NY (US)

(21) Appl. No.: 10/908,100

(22) Filed: Apr. 27, 2005

(51) Int. Cl. G06F 17/50

(52) U.S. Cl. 703/16

(57) ABSTRACT

A method in accordance with the invention for modeling period jitter for testing a modeled logic circuit. Clock signals can be derived from a phase lock loop having a voltage controlled oscillator for use to evaluate timing problems within a modeled circuit. An estimation of period jitter for the modeled clock signals can be made by considering the number of periods of the voltage controlled oscillator signal which generates the clock signal occurring within a test interval. By using the relationship as an index to a table, a value of period jitter may be obtained from a table which increases longer the timing interval being considered. Instructions for carrying out the steps of correcting intervals between clock signals used in static timing tests may be stored on a computer readable medium along with a table containing the amount of period jitter as a function of the number of VCO periods occurring within a testing period. The improved accuracy in period jitter estimation improves the reliability of static testing of modeled circuits.

The present invention relates to the process for modeling circuit designs before they are manufactured. Specifically, a method for making improved estimates of clock jitter for use in static timing tests is disclosed.

### BACKGROUND OF THE INVENTION

Integrated digital circuit design has progressed to the point where designs can be modeled in software before they are physically implemented in silicon. One system for modeling such circuits is referred to as the EinsTimer™ static timer which analyzes the circuit as a net list of interconnected circuit elements, which may include data storage elements, gates, and other circuit elements. Data storage elements are generally controlled by clock signals and may include latches, flip-flops, and memory arrays. The net list defines the connections from the exterior of the circuit to the circuit elements, and the connection between each element within the circuit. An external clock signal which is used to operate the circuit as well as data signals are conveyed to various circuit elements which include storage elements. The various paths between circuit elements, represented by the net list, produce timing delays which, if sufficiently large, result in timing problems preventing the circuit from operating correctly. Accordingly, timing data must be obtained from the modeled circuit for every path that data takes, as well as the paths that clock signals take, to make certain that data arrives neither too early, nor too late, at a circuit element. As part of the modeling process, real timing rules are loaded in the system which identifies the various timing requirements between elements within the circuit to thoroughly analyze the circuit timing.

Static timing tests for carrying out these measurements are computed from the net list which identifies each of the delays encountered by a clock pulse propagating from one latch to another latch. The first of these static timing tests is a setup test. The EinsTimer™ static timing tests calculate for each path of data to a given latch the delays encountered by the data. The longest data path from a pair of latches to another pair of latches, defined as the launching storage element and capture storage element, respectively, is used in a setup test. The setup test measures the difference in arrival time between the earliest clock signal received by the capture storage element, and the time of arrival of the latest data received from any launching storage element. There will in general exist data paths from many different launching storage elements to any given capture storage element, and the setup test will be applied to the latest arriving data signal along any of these paths. If the test demonstrates that the latest data at the input to the capture storage element has stabilized before the time of the earliest arriving clock edge, then the system passes the setup test.

A corresponding hold test is done for the shortest (earliest) data path from a launching storage element to a capture storage element, and the latest clock input signal received by the capture storage element. The shortest data path between any launching storage element and a given capture storage element is identified as being that which results in the earliest data arrival time at the capture storage element, and the test is conducted to determine if the data remains valid and stable for enough time to latch the incoming data from the launching storage element when compared to the latest clock edge.

When carrying out these tests, assumptions are made about the clock pulse stability. As is known in digital circuit design, clock signals, originating from phase lock loop circuits, have a certain amount of period jitter associated with them, so that from cycle to cycle, the timing between pulses or clock edges varies. Static timing tests must take into account the period jitter to accurately predict clock signal propagation speed. Because the timing difference in timing between pairs of clock edges caused by jitter may either increase or decrease the time between the clock edges, static timing tests must assume a value of jitter, which ensures that the timing test will be satisfied even in the presence of jitter. This assumed jitter is a source of testing error when the assumed value differs from the actual jitter. The result of assuming a period jitter less than the actual jitter can produce false test results indicating that the circuit will pass the test, and can therefore result in manufacture of a defective circuit. If the assumed jitter exceeds the actual jitter the timing tests will be overly conservative and may predict timing failure when it will not in fact occur. Accordingly, there is a need to determine an appropriate amount of period jitter for conducting static timing tests.

It has been known that the source of period jitter for the clock signal is the original circuit which produces the clock signal. Typically, these are phase lock loop (PLL) circuits which have a voltage controlled oscillator (VCO) controlled in frequency and phase. As the number of clock periods increases, the phase noise is additive, and accumulates non-linearly. The period jitter is therefore effectively proportional to the number of VCO clock periods between two timing edges. The present invention determines a value of jitter for static timing tests based on this observation.

The conventional way for accounting for PLL period jitter is to reduce the clock cycle time by the period jitter for rising to rising edges, and falling to falling edges of the clock signal. However, during typical hold tests, the difference between the edges is zero because the launch and capture edges are the same. Therefore, in these instances no timing adjustments for period jitter should be made. However, if the hold test is done between two different clock edges, then the period jitter should be taken into account.

In setup tests where the launch clock signal and capture clock signals are different, and the launch clock occurs before the capture clock signal, a clock adjust is not required. In these instances, the period jitter should be limited to the amount of time between the two clock edges, not a full period jitter. Further, when a timing path from the rising edge to the falling edge or the falling edge to the rising edge of a single clock signal is considered, the period jitter is usually assumed to be zero.

Inaccuracies in the measurements due to incorrect estimates of period jitter can result in the approval of a design which when later implemented in silicon fails, or in an overly conservative design which wastes chip area, chip power, and design effort.

### SUMMARY OF THE INVENTION

The method according to the invention models period jitter occurring between a launching clock signal and a capture clock signal in static timing tests of a modeled circuit. The period jitter is selected to guarantee a worst case timing analysis for setup and hold tests. The period jitter is selected from a table of values which uses an index which is related to the time elapsed between the launch storage element clock signal and the capture storage element clock signal. Thus, as the timing interval represented by these clock signals increases, the amount of jitter increases as well.

The value of clock signal period jitter is preferentially determined as a function of the number of VCO clock periods which occur between a launch clock signal and the capture clock signal used in the static timing analysis tests. Once this interval is determined, including any adjustments made to the timing interval based on the arrival times of the capture storage element and launch storage element clock signals, the number of periods of VCO clock signals in the timing interval may be determined. This number is used as an index to the table to select the appropriate value of period jitter to add to the timing interval for a setup test, and to subtract from the timing interval during a hold test, to derive the most pessimistic assessment of circuit performance. Alternatively, the amount of period jitter may be determined directly as a function of the clock signal separation, without first determining a number of VCO cycles. This allows the inventive method to be used for sources of jitter other than PLLs which are also dependent on edge separation.

### BRIEF DESCRIPTION OF THE DRAWINGS

FIG. 1 is an illustration of how the EinsTimer™ static timing analyzer determines the propagation times between storage elements of a circuit being modeled;

FIG. 2 illustrates the period jitter which occurs on a cycle-to-cycle basis between adjacent clock cycles over a random sample of adjacent clock cycles;

FIG. 3A shows the setup test for the modeled circuit;

FIG. 3B illustrates the hold test for the modeled circuit;

FIG. 4 illustrates the adjustment of clock pulses during a static timing analysis for the three possible alignments of ideal launch clock signals and ideal capture clock signals;

FIG. 5 is a flowchart of the process carried out by instructions stored on a computer readable medium for implementing a preferred embodiment of the invention;

FIG. 6 illustrates a typical PLL circuit for generating clock signals;

FIG. 7 illustrates the relationship between the VCO clock edge and the output clock edge that it produces;

FIG. 8 illustrates the VCO clock edge and the output clock edge that it produces for multi-phase PLL during static timing;

FIG. 9 illustrates a circuit including transparent latches and multi-cycle paths;

FIG. 10 illustrates the launching and capturing clock edges and VCO cycles for the circuit of FIG. 9;

FIG. 11A illustrates a method for accounting for timing adjusts when determining a clock jitter value;

FIG. 11B illustrates an alternative method for accounting for timing adjusts when determining a clock jitter value; and

FIG. 11C illustrates yet another method for accounting for timing adjusts when determining clock jitter.

FIG. 11D illustrates still another method for accounting for timing adjusts when determining clock jitter.

### DESCRIPTION OF THE PREFERRED EMBODIMENT

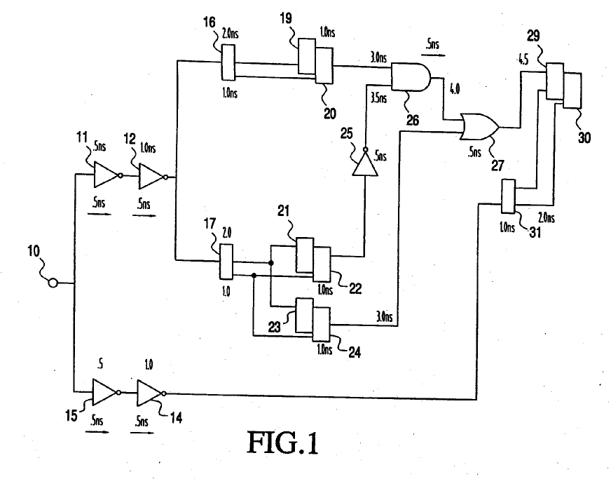

Referring now to FIG. 1, an illustration of a modeled electronic circuit is shown as it applies to conducting static timing tests. Using the EinsTimer™ static timing analyzer, each storage element may in many cases be modeled as a pair of latches. Other clock storage elements such as flip-flops and memory arrays are well-known to those skilled in the art and may also be modeled in static timing analyzers such as EinsTimer™, and may be considered interchangeable with the pairs of latches in the following discussion. The pair of latches serve as either a launching storage element, presenting data to a data path, or a capture storage element for receiving data from a data path. A single pair of latches may serve both of these purposes with respect to different data paths or sets of data paths. In order to verify circuit functionality, static timing tests measure the time of arrival of a data signal at the capture storage element which is the result of delays in time incurred by data which is transferred between a launching storage element and the capture storage element, and the time of arrival of a capture clock signal to the capture storage element. The two times are compared to determine if the capture storage element will be able to latch the data it receives from the launching storage element.

FIG. 1 shows an external clock terminal 10 which receives a clock signal for operating each of the storage elements in the circuit. Although shown for simplicity here as arriving from a source external to the chip, the clock signal will more commonly be generated from a PLL on the same chip as the storage elements being controlled by it. The early and late delays of the circuit elements in this example will be assumed to be the same for simplicity of explanation, although in practice minimum and maximum delays for each circuit element may be computed, with minimum delays being used to compute early arrival times and maximum delays being used to compute late arrival times. Each storage element may comprise a pair of latches connected as shown in FIG. 1. The clock signal diverges and propagates through two pairs of inverters 11, 12 and 14, 15. As the clock signal propagates through each circuit element including the inverters 11, 12 and 14, 15, the signal is subject to delay of 0.5 ns through each element. Additionally, any wiring between the elements introduces delay to the signal which must be accounted for in the static timing tests.

The clock signal from inverter 12 is split by the clock signal splitters 16 and 17 into a pair of true and complement clock signals to control the latch pairs fed by them. Although in practice each of the two clock signals generated by the clock splitter will have its own arrival time and setup and hold tests at the capture storage element may involve both of these, for simplicity in this example only a single arrival time will be considered for the pair of outputs of each clock splitter. The cumulative delay of the clock signal includes 0.5, 0.5, and 1.0 ns for a total of 2.0 ns of delay. (Delays incurred due to wiring are included in the individual component delays in this example). These times represent the early arrival time for data at launch storage elements 19, 20, 21, 22, and 23, 24. Similarly the delays through inverters 14 and 15 and clock splitter 31 sum to a total of 2.0 ns, representing the late arrival time at capture storage element 29, 30.

Latches 19 and 20 add another 1.0 ns of delay for data which is being clocked as a result of receipt of the clock signals. Thus, data appears on the output of latch 21, 22 and 24, 1.0 ns later than the arriving clock signal at its clock input. The path for data produced by the launching latches 21 and 22 forming a launching storage element extends through inverter 25 for a delay of 0.5 ns, through an AND gate 26, for an additional delay of 0.5 ns, and through OR gate 27 for another 0.5 ns of delay. Latches 29 and 30 constitute a capture storage element for data which is generated from launching storage element formed by latches 21 and 22. This represents the longest data path from all the launching storage elements to the capture storage element 29, 30. A clock signal is supplied to the capture storage element 29, 30 through inverters 14, 15 and clock splitter 31.

The same analysis is conducted between latch pair 19, 20 and capture storage element 29, 30 as well as between the launching storage element 23, 24 and the capture storage element 29, 30. The data path having the longest delay between launch storage elements and capture storage element 29, 30 is used to conduct a setup test. The data path having the shortest delay is used to conduct a hold test.

Referring now to FIG. 3A, the setup test is shown as a measurement of the time interval between the longest data path, producing the latest arriving data, from a launching storage element to the D input of a capture storage element, which in the example of FIG. 1, comprises latches 29 and 30. Each of the paths from launching storage elements formed by latches 19, 20, 21, 22 and 23, 24 is computed to determine the longest and the shortest data path.

Although the analysis of the circuit modeled in FIG. 1 has been described as a series of separate path analyses, in practice most static timing analyzers do not perform explicit path analysis, as the number of paths in a circuit may grow exponentially with the number of circuit elements in the circuit. Instead, the commonly known method of node-oriented analysis is performed. In node-oriented analysis a late arrival time is computed at each node in the timing graph. A timing graph is an abstraction of the timing characteristics of a circuit, whose nodes normally correspond to circuit element pins, and are locations at which signal arrival times may be computed, and whose edges normally correspond to delays through wires or circuit elements. A separate late arrival time is generally computed at a node for every clock phase which can launch data can pass through the node, and represents the latest time at which a signal launched by the clock phase may arrive (become stable) at the node. It is computed as the maximum over all other nodes directly feeding the given node of the late arrival time at the other node for the clock phase of interest plus the late, or maximum, delay between the other node and the given node. An early arrival time can be computed in a similar manner for each clock phase which can propagate data to a node, as the minimum over all other nodes directly feeding the given node of the early arrival time at the other node for the clock phase plus the early, or minimum, delay between the other node and the given node. The use of node-oriented analysis creates some complications in the present inventive method under certain circumstances, which will be described later.

A setup test measures in accordance with FIG. 3A, the time between the rising edge of a capture clock signal received by latches 29, 30 and the time that valid data is received over the longest data path (identified as the path from launch storage element 21, 22. The time interval is measured from the earliest clock signal arriving at the capture storage element 29, 30 to the arrival of data shown in FIG. 3A at the capture storage element 29, 30.

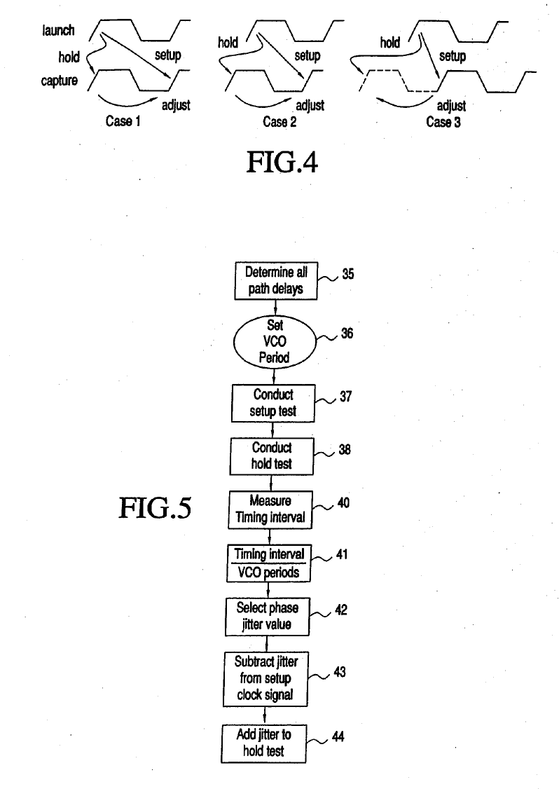

The hold test shown in FIG. 3B is conducted by measuring the time between the latest clock signal received by the capture storage element and the arrival of data over the shortest (earliest arriving data) path (which is identified to be from the storage element formed by latches 23, 24) to capture storage element 29, 30. The setup and hold tests are done after making an adjustment in the clock signal. There are three scenarios shown in FIG. 4 for clock adjusts which must be considered when conducting the static timing tests.

In case 1, when the ideal launch clock signal occurs at the same time as the ideal capture clock signal, the data output from the launch storage element in one cycle is stored in the capture storage element during the following cycle, and the setup test is adjusted so that one full cycle of clock occurs between the launch clock and capture clock. The hold test has no clock adjust associated therewith.

For case 2, when the ideal launch clock occurs after the ideal capture clock, the data output from the launch storage element in one cycle is again stored in the capture storage element during the following cycle, and the setups are adjusted so that the capture clock is delayed by one full cycle. The hold tests have no adjustment to the clock signal.

Finally, for case 3, when the ideal launch clock occurs before the ideal capture clock, the data output from the launch storage element is stored in the capture storage element on the next capture clock, so the setup tests have no adjust, and hold tests are adjusted so the capture clock is adjusted a full cycle before the ideal launch clock.

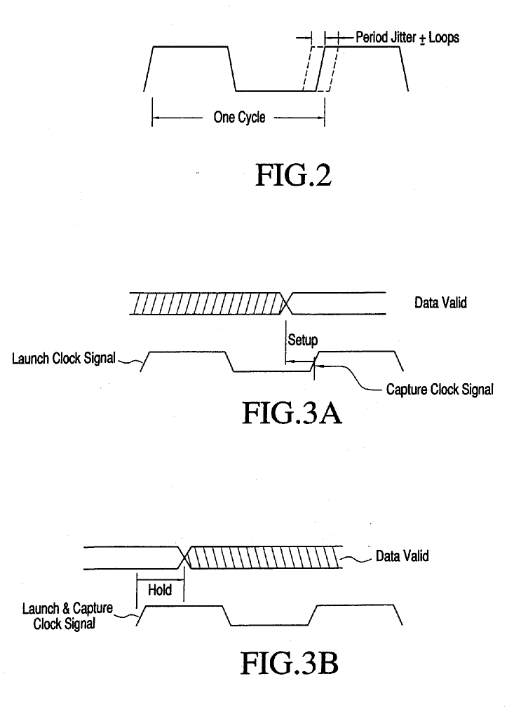

The accuracy of the static timing test is affected by any phase jitter occurring on the clock signal. As shown in FIG. 2, the period of the clock signal, which originates from a PLL, can vary cycle to cycle. The more cycles of VCO clock signals that occur between two clock edges, the larger the jitter in the period between those edges, as it is cumulative over several cycles of clock signal. The period jitter shown in FIG. 2 for a 2 ns clock is plus or minus 50 ps. Thus, when considering the clock cycle, 50 ps of period jitter must be subtracted, thereby reducing the capture clock signal period to 1.950 ns to more accurately reflect timing conditions within the circuit when doing a setup test for tests that have clock adjusts. During a hold test, 50 ps would be added to capture clock signal period if the test requires a clock adjust to achieve a clock signal period of 2.05 ns.

The present invention determines a jitter period by determining for each static timing test the actual amount of clock adjust (if any), plus the time between clock edges, divided by the VCO clock period. Once the number of VCO clock periods is determined between the measurement interval (including clock adjusts and time between clock edges), the appropriate amount of jitter is determined. As part of the timing rules of the circuit modeling system, the VCO jitter data as a function of the number of VCO periods is entered into the system. This data includes the realization that if zero VCO clock periods have elapsed, there is no jitter. More generally, the jitter may be computed as a function of the time separation between the launching and capturing clock signals associated with a timing test.

The following table of jitter values can be derived (as an example) for a VCO which has a period of 2.0 ns.

```
TABLE 1
  0 ps of jitter would be applied if 0 VCO clock periods (0.0 ns)
have elapsed
  25 ps of jitter would be applied if 1 VCO clock period (1.0 ns)
have elapsed
  50 ps of jitter would be applied if 2 VCO clock periods (2.0 ns)
have elapsed
  75 ps of jitter would be applied if 3 VCO clock periods (3.0 ns)
have elapsed
100 ps of jitter would be applied if 4 VCO clock periods (4.0 ns)
have elapsed
110 ps of jitter would be applied if 5 VCO clock periods (5.0 ns)
have elapsed
200 ps of jitter would be applied if 6 or more VCO clock periods (6.0 ns)
have elapsed
```

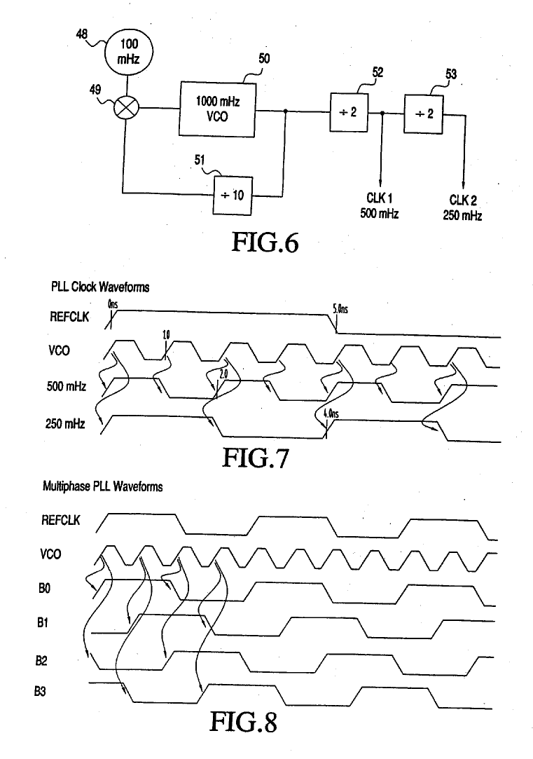

Referring now to FIG. 5, the practical implementation of the process for estimating jitter in conducting static timing tests is shown as a flow chart. The instructions for carrying out the process are stored on a computer readable medium which is read by the modeling tool. The flow chart illustrates how the setup and hold tests of FIGS. 3A and 3B are accomplished using the jitter periods of Table 1. The path delays illustrated in FIG. 1 are determined in step 35 for all launch and capture clocks, as well as for the clock signal paths for the modeled circuit, in accordance with the prior EinsTimer™ analyzer. As stated previously, the EinsTimer™ analyzer and most other static timing analyzers do not directly determine path delays for all launch storage element to capture storage element paths, due to the potential for having an exponential number of such paths to analyze, but instead utilize node-oriented analysis. The VCO period is determined in step 36 from the timing rules for the PLL which generates the clock signal applied to pin 10 of the integrated circuit package. The VCO period of 1.0 ns is supplied as part of the parameters for the timing rules of the modeling tool. As will be evident with discussion of the specific examples for this process, the clock signal is derived as shown in FIG. 6 from a conventional PLL. A reference source 48 operating at a frequency of 100 MHz is used to stabilize the frequency of VCO 50. The feedback path divider 51 applies a divided by 10 signal to the phase detector 49 which establishes a nominal output frequency from the VCO 50 at 1000 MHz. In the examples to be described, the VCO output frequency is divided by two to derive a first clock signal CLK1 at 500 MHz, and divided again by two in divider 53 to obtain a second clock signal CLK2 operating at 250 MHz.

Next, the setup tests of FIG. 3 are conducted for the longest signal paths identified from FIG. 1 in step 37 to the capture latch. Similarly, the hold tests are conducted in step 38 for the shortest signal path of FIG. 1 to the capture latch. Although only a single capture latch is illustrated in FIG. 1, a circuit will in general have many capture storage elements, and any storage element in the circuit may be a launch storage element for one set of data paths and a capture storage element for another set of data paths. Before measuring the timing intervals of FIGS. 3A and 3B between arriving data and the capture clock signal, clock adjusts are made to the capture clock signal in step 40 as well as a compensation for period jitter.

The amount of period jitter to add or subtract to the capture clock signals in the static timing tests is determined in steps 41 and 42. The timing interval between launch clock and capture clock, after making any appropriate clock signal adjustment, is divided by the VCO period to derive the number of VCO periods within the timing interval. A value of period jitter is then selected from Table 1 in step 42. In the case of setup tests, the value of period jitter is subtracted from the setup test timing interval in step 43. As for the hold test, the amount of period jitter is added in step 44 to the timing interval between launch and capture clocks. The process of computing the period jitter can be illustrated with respect to the circuit of FIG. 1.

In the modeled circuit shown in FIG. 1, the setup test would involve the data path from launching storage element 21, 22 to the capture storage element 29, 30. To conduct the test, the clock signal would, under the scenario of FIG. 1, arrive at launch storage element 21 and 22 in 2.0 ns. The clock signal would arrive at the capture storage element 29, 30 in 2.0 ns. Since the ideal launch clock occurs coincident with the ideal capture clock, in accordance with the clock adjust rules relating to FIG. 4 case 1 the capture clock would be adjusted one full cycle for set up tests.

The clock signal for the capture latch would be further modified by the value of jitter. Since the clock signals for capture storage element 29, 30 occur one full clock cycle later (including the clock adjust) than for the launch clock inputs to launch storage element 21, 22, the period jitter would be determined by dividing the clock cycle time of 2.0 ns which is the adjust time, by the VCO period of 1.0 ns, to obtain a value of 2. Using 2 as an index for the Table yields a correction of 50 ps.

Applying the foregoing, the timing interval represented by the difference between the time 21 and 22 are clocked, and the capture latch 29, 30 are clocked, taking into account jitter and the adjust would be 2.0 ns−0.050 ns=1.95 ns.

The total propagation time from the clock source 10 through each of the inverters 11, 12, clock splitter 17, latches 21, 22, inverter 25, gate 26, and OR gate 27 is 4.5 ns. Thus, data arrives at the input of capture storage elements 29, 30 at 4.5 ns, and the clock signal arrives at 2.0 ns, plus 2.0 of clock adjust, minus 0.05 ns or 3.95 ns. Since the latch data arrives later than the clock signal, the test fails.

Similarly on a hold test, the path including storage elements 23, 24 and OR gate 27 is considered, representing the earliest arrival time for data at capture storage elements 29, 30. Since the ideal arriving clock signal to launch storage element 23, 24 is simultaneous with the arrival at capture storage element 29, 30, the clock arrival time is not adjusted. In this circumstance, there is zero difference between the ideal arrival time of the edges of the clock signal applied to latches 23 and 24 and those of clock applied to capture storage element 29 and 30 (FIG. 4, case 1). According to Table 1, the period jitter would be zero. Data from storage element launch 23, 24 would arrive at capture storage elements 29, 30, 3.6 ns after the clock pulse arrives at pin 10. The clock pulse would arrive 2.0 ns, or earlier than the data, and the hold test therefore passes. While the foregoing explanation was limited to a launch clock and capture clock in the same clock domain, the analysis also is applicable when the clock domains are not the same. In each instance, it is only the number of VCO clock periods which occur between edges of the launch clock and capture clock which determines the estimated jitter.

FIG. 7 illustrates the two ideal clock signal domains produced by the PLL of FIG. 6 which are also derived from the PLL VCO clock. Setup and hold tests using either clock can be conducted by the static timing software of the EinsTimer™ analyzer. Table 2 demonstrates for each ideal clock signal domain of 250 MHz the setup and hold launch clock edges, capture clock edges as well as the appropriate clock adjusts for each of the cases 1-3 of FIG. 4. The VCO periods contained within the total adjust are illustrated along with a representative period jitter for each of the cases for the two domains. Thus, when making measurements using the slower 250 MHz clock speed which was divided down from the 1000 MHz VCO frequency, period jitter would be recovered from Table 2 and used to modify the time of arrival of the clock signal at the capture latch, thereby shortening the total adjust time for the setup tests, and lengthening the total adjust time for the hold tests.

TABLE 2

| | | Launch | Capture | Clock | Total | VCO | Period |
|---|---|---|---|---|---|---|---|
| Test | Case | Edge | Edge | Adjust | Difference | Periods | Jitter |
| Setup | 1 | R 0.0 | R 0.0 | 4.0 | 5.0 | 4 | 100 ps |
| Setup | 1 | F 2.0 | F 2.0 | 4.0 | 5.0 | 4 | 100 ps |
| Setup | 3 | R 0.0 | F 2.0 | 0.0 | 2.0 | 2 | 50 ps |
| Setup | 2 | F 2.0 | R 0.0 | 2.0 | 2.0 | 2 | 50 ps |
| Hold | 1 | R 0.0 | R 0.0 | 0.0 | 0.0 | 0 | 0 ps |
| Hold | 1 | F 2.0 | F 2.0 | 0.0 | 0.0 | 0 | 0 ps |
| Hold | 3 | R 0.0 | F 2.0 | 4.0 | 2.0 | 2 | 50 ps |
| Hold | 2 | F 2.0 | R 0.0 | 0.0 | 2.0 | 2 | 50 ps |

FIG. 8 illustrates multi-phase signals from a PLL. As shown in FIG. 8, there are four outputs of the same period, B0, B1, B2 and B3, all of which are generated with respect to an edge of the VCO signal of the PLL. Each of the B0 through B3 waveforms are shifted 90° from each other. Accounting for period jitter with the multi-phase PLL during static timing analysis is complex, because every combination of edges must be accounted for as shown in FIG. 8. Each of the edges of the multi-phase clock signals is tied to the edge of the VCO output signal, and the VCO signal is the source of the periodic jitter on each of the output clocks B0 through B3.

In accordance with the present invention, period jitter may be assessed for each of the phases, based on the number of VCO periods have occurred within the static timing intervals. Thus, each clock output signal can have a period jitter based on these criteria.

As stated previously, node-oriented analysis is commonly used in static timing analyzers such as the EinsTimer™ analyzer. In node-oriented analysis the late or early arrival time at a node for a clock phase does not have explicitly stored with it any information about the longest path to the node which resulted in that arrival time, and in particular, about the launch storage element for that path. In the absence of any multi-cycle paths or transparent latches, to be explained below, this is not a problem, as any data launched by a clock of a particular clock phase and captured by a clock of another particular clock phase will have the same time interval and therefore the same number of VCO cycles between its launch and capture clocks, so the jitter adjustment required will not depend on the particular launching storage element from which the arrival time at the data input of capture storage element was derived, but only on the clock phase which launched it and with which it is therefore labeled or associated.

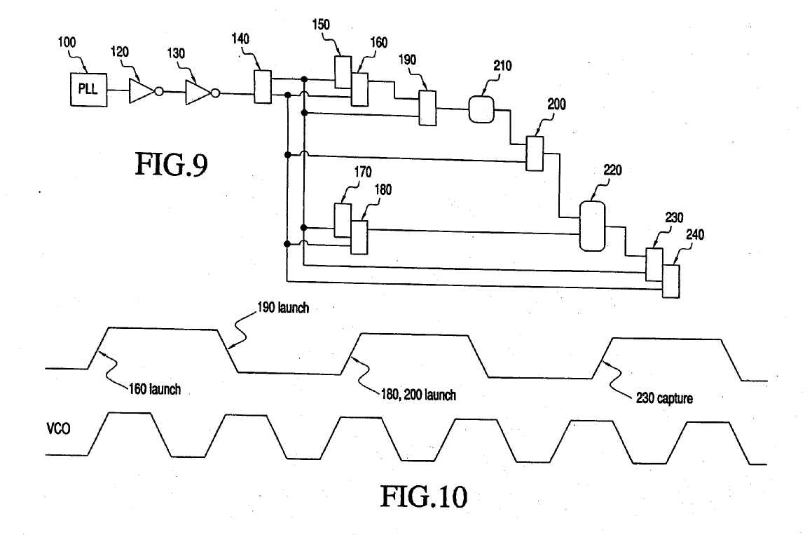

FIG. 9 shows a circuit containing both transparent latches and a multi-cycle path. A clock signal is generated by PLL 100 and propagated through a clock distribution network consisting of inverters 120 and 130 and split into separate latch clocks by clock splitter 140. Blocks 210 and 220 represent combinational logic networks (e.g., of AND, OR, and NOT gates) whose specific functions are unimportant to the present explanation and are therefore omitted. The path from latch 180 to 230 is a conventional single-cycle path, so that data launched from latch 180 by one rising clock edge will be captured by latch 230 on the following rising edge of the same clock as shown in FIG. 10. FIG. 10 shows the VCO clock signals which occur between the timing edges of the latches of FIG. 9, so the launch to capture clock separation used to compute clock jitter is a single clock cycle, or two VCO cycles. Latches 190 and 200, however, are transparent latches, and as shown below, will result in a path whose launch to capture clock separation is two clock cycles, or four VCO cycles. Specifically, latch 190 is clocked by the falling edge of a clock signal, and while the clock is low any data changes occurring at the input of latch 190 will immediately propagate to the output of latch 190. Similarly, latch 220 is clocked by the rising edge of the clock signal, and while the clock is high any data changes occurring at the input of latch 220 will immediately propagate to the output of latch 220. Thus data which is launched by latch 160 may pass transparently through latch 190, block 210, latch 200, block 220, and may thus be captured by latch 230 two clock cycles or four VCO cycles after having been launched by latch 160. As data signals pass through a transparent latch they are typically relabeled with the clock phase which controls the transparent latch and have their arrival times adjusted by an appropriate amount to make them consistent with this relabeling, thus the signal output arrival time from latch 190 will be labeled as being launched by the falling clock edge, and the signal output arrival time of latch 200 will be adjusted back one cycle (i.e., will have one clock period subtracted from it) and labeled as being launched by the rising clock edge. This is the same label used to identify data launched by latch 180, and thus the timing data from latch 180 and from latch 200 will not be kept separate as they pass through combinational logic block 220, and a single output arrival time labeled with the rising clock edge will be propagated to the input of latch 230. Timing adjusts in propagated arrival times similar to those imposed when arrival times are relabeled as they pass through a transparent latch may occur due to other reasons, including simply user assertion of adjusts (e.g., to identify a multi-cycle path through the circuit) and result in similar difficulties.

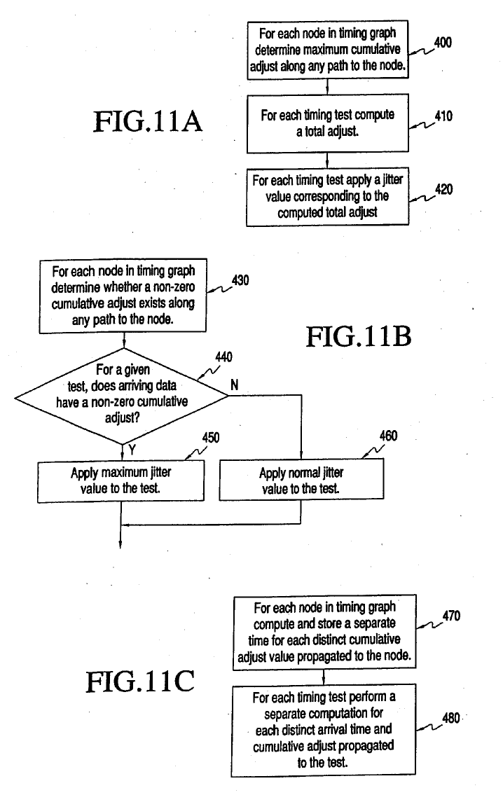

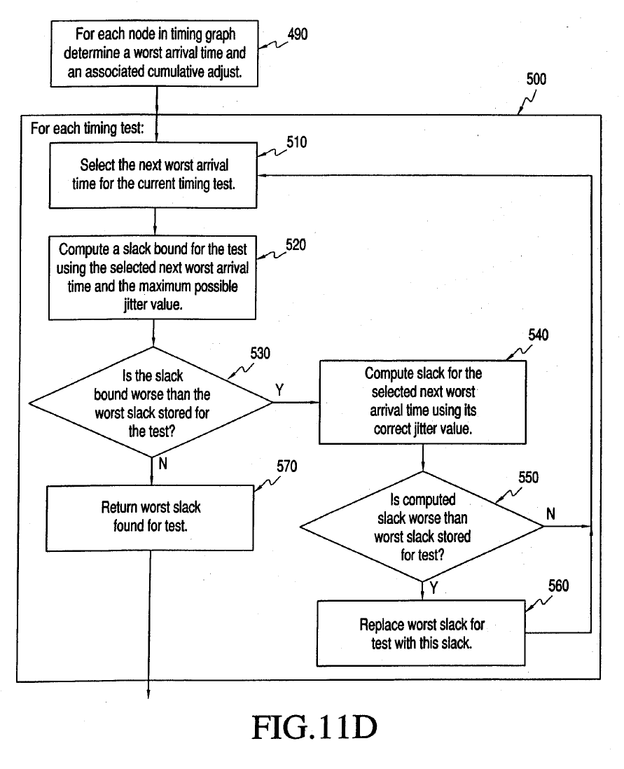

One method for accounting for timing adjusts in propagated arrival times is to associate with an arrival time for a clock phase at a node a maximum cumulative adjust for any path which could propagate data of that clock phase to the node. Thus the data output from latch 180 will have zero maximum adjust as it enters block 220. The data output from latch 200, however, will have a maximum adjust of one clock cycle as it enters block 220. The output of block 220 will have a single arrival time labeled as being launched on the rising clock edge, and with a maximum cumulative delay of one clock cycle, as this is the maximum of the two cumulative adjusts propagated into it. Note that this maximum cumulative adjust is computed separately from the arrival time, and thus the maximum arrival time at the output of block 220 could be due to the path from latch 180 which had no cumulative adjust, while the associated maximum cumulative adjust is due to the path from latch 160 through latches 190 and 200. When jitter computation is performed at a timing test this maximum cumulative adjust must be added to the adjust normally performed at the timing test to determine the launch to capture edge separation used to determine the number of VCO cycles between them and therefore the jitter value to be applied. In the example of FIG. 9, a jitter value of 100 ps, corresponding to a launch to capture edge separation of four VCO cycles, would be applied to a setup test performed on data arriving at latch 230 labeled as being launched on the rising clock edge. The four VCO cycles used to determine this jitter value would be the sum of the single clock cycle (two VCO cycle) maximum cumulative adjust due to the path from latch 160 through latches 190 and 200, plus the single clock cycle (two VCO cycle) adjust normally performed on a setup test between data launched and captured by ideal clock edges occurring at the same time within the clock cycle, as described in case 1 above. This method is shown in FIG. 11A. In step 400 the maximum cumulative adjust is determined for each node in the timing graph. In step 410 this maximum cumulative adjust, as determined at a timing test. In step 420 the jitter value corresponding to the total adjust for a timing test is applied to that timing test. This method has the advantage of not requiring additional arrival times to be stored on nodes, but may produce an overly conservative result, as the critical path to the timing test (the longest late path or shortest early path) may have a smaller cumulative than that used.

A variation on this method which is even more conservative but which requires even less data storage at each node is to simply associate with an arrival time for a clock phase at a node a bit flag which is set to true whenever any path exists along which data of that clock phase could propagate to the node with a non-zero cumulative adjust. In this case, a timing test performed against an arrival time whose non-zero cumulative adjust flag is true must use the maximum possible jitter value. In the example of FIG. 9 a jitter value of 600 ps, corresponding to a launch to capture edge separation of six of more VCO cycles, would be applied to a setup test performed on data arriving at latch 230 labeled as being launched on the rising clock edge, as this data would be flagged as having a non-zero cumulative adjust due to the path from latch 160 through latches 190 and 200. This method is shown in FIG. 11B. In step 430 it is determined for each node in the timing graph whether there is a non-zero cumulative adjust along any path to the node. In step 440 it is decided at a timing test whether arriving data for the timing test has a non-zero cumulative adjust. If this is true, a maximum jitter value is applied to the timing test in step 450. If it is not true the normal jitter value for the launch and capture clock edges for the test is applied to the test in step 460.

Another method of accounting for timing adjusts in propagated arrival times is to distinguish between arrival times with different cumulative adjusts by giving them different labels and not combining them. Thus the data launched by latch 180 would be labeled as launched by the rising clock edge with zero cumulative adjust, the data launched by latch 160 and propagated through latches 190 and 200 would be labeled as launched by the rising clock edge with one clock cycle of cumulative adjust, and the data launched directly by the clock edge applied to latch 200 and not propagated from latch 160 would be labeled, like that from latch 180, as launched by the rising clock edge with zero cumulative adjust. The two arrival times labeled as launched by the rising clock edge with zero cumulative adjust would be combined as they propagated through block 220, but the differently labeled arrival times would not, and thus the timing tests at latch 230 would be applied separately to each uniquely labeled arrival time, and the correct jitter value could be used in each case. This method is shown in FIG. 11C. In step 470 a separate arrival time is computed at each node in the timing graph for every distinct cumulative adjust value which can be propagated to the node. In step 480, each timing test is applied to all the arrival times propagated to the test in step 470 to determine a separate slack computation with the jitter value applied being the sum of the normal jitter value for the test and the cumulative adjust with which the particular arrival time being tests is associated. This method is more accurate than the previously described method, but may require additional data storage during the timing analysis process, particularly in a design with many transparent latches and thus many different cumulative adjust values and arrival time labels.

Yet another method of accounting for timing adjusts in propagated arrival times is to associate with an arrival time for a clock phase at a node the cumulative adjust for the path along which the dominant (maximum late or minimum early) arrival time was propagated. This method avoids both the additional storage required by the method of FIG. 11C and the conservatism of the methods of FIG. 11A and FIG. 11B, but may require some iteration to avoid giving a falsely optimistic result. To see this consider again the example of FIG. 9. Assume for purposes of explanation that the clock arrival time at latch 230 is zero, the setup test value is zero, the clock cycle is 2.0 ns, the path from latch 160 and propagated through latches 190 and 200 results in an arrival time at latch 230 of 1.925 ns, and the path from latch 180 results in an arrival time at latch 230 of 1.95 ns. The data from latch 180 is latest and will therefore be propagated to latch 230 along with its cumulative adjust of zero. The timing test adjust will be one clock cycle (2.0 ns) or two VCO cycles, and so a jitter value of 50 ps or 0.05 ns will be applied to the test resulting in a zero slack at the test (a clock arrival time of 0.0 minus a setup test of 0.0 ns minus a data arrival time of 1.95 ns plus a test adjust of 2.0 ns minus a jitter value of 0.05 ns). However if the path from latch 160 and propagated through latches 190 and 200 is considered, a worse slack is discovered. In this case the cumulative adjust plus timing test adjust will be two clock cycles (4.0 ns) and the corresponding jitter value will be 100 ps. So a slack value of −0.025 ns or −25 ps is found for this test (a clock arrival time of 0.0 minus a setup test of 0.0 ns minus data arrival time of 1.925 ns plus a test adjust of 2.0 ns minus a jitter value of 0.1 ns). Thus it is necessary in this method to iteratively consider secondary paths to a test in reverse order of their arrival time until it is determined that applying even the maximum possible jitter value to the slack of the considered path would not cause it to be worse than the worst slack computed for previous paths to the test. Methods for tracing secondary paths to a test in a node-oriented static timing analysis and determining their arrival times are well-known to those skilled in the art. In the example of FIG. 9 this iterative tracing of secondary paths would have discovered the worst slack demonstrated above due to the path from latch 160 and propagated through latches 190 and 200.

This method is show in FIG. 11D. In step 490 compute the worst arrival time at each node and record with it the associated cumulative adjust for the path which caused that arrival time. The sub-steps of step 500 are then performed on each timing test in the circuit. In step 510 the next worst arrival time at a timing test is identified. In step 520 a slack bound for this next worst arrival time is computed using the maximum possible jitter value. In step 530 it is determined whether the slack bound is worse than the worst slack computed thus far for the test. The effect of this decision is to determine whether it is possible for any path to the test which has not yet been analyzed could possibly case a slack which is worse than the worst slack determined so far. If the slack bound is not worse, in step 570 the worst slack computed for the test is returned. If the slack bound is worse, a real slack for the next worst arrival time is determined in step 540 using the correct jitter value for the cumulative adjust associated with the next worst arrival time. In step 550 it is determined whether the slack computed for the next worst arrival time is worse than the worst slack computed so far for the test. If the answer to the decision in step 550 is yes, the computed worst slack replaces the previously saved worst slack in step 560 and the method then returns to step 510 where the next worst arrival time for the test is considered. If the answer to the decision in step 550 is no, the previously stored worst slack is retained and the method returns directly to step 510.

While the invention has been particularly shown and described with reference to preferred embodiments thereof, it will be understood by those skilled in the art that various changes in form and details may be made therein without departing from the spirit and scope of the invention.

What is claimed is:

1. A method for modeling period jitter for static timing analysis of a logic circuit wherein simulated clock signals are derived from a phase locked loop, comprising:
determining the time difference between two clock edges defining a test interval; and selecting a value of jitter which is dependent on said time difference.

2. The method for modeling period jitter according to claim 1 wherein said phase locked loop includes a voltage controlled oscillator and said selection of a value of jitter further comprises:
determining the number of time periods of said voltage controlled oscillator which occur during said time difference; and
selecting a value of jitter which is dependent on said number of voltage controlled oscillator periods.

3. The method for modeling period jitter according to claim 1 wherein said time interval includes the difference between a capture clock signal for a capture latch which receives data, and a launch clock signal for a launch latch which provides data to said capture latch.

4. The method for modeling period jitter according to claim 3 wherein said time interval includes any adjustments to said clock signals which are introduced during testing.

5. The method according to claim 2 wherein said values of jitter are selected from a table which includes a value of period jitter for each number of time periods of said voltage controlled oscillator signal.

6. The method according to claim 5 wherein said table is created by measuring the amount of period jitter in said voltage controlled oscillator signal contained in each number of periods in said table.

7. The method according to claim 1 further comprising:
subtracting said value of jitter from said time interval to derive a jitter corrected time interval.

8. The method according to claim 7 wherein said time interval includes any clock signal adjustments which are made during said testing.

9. The method according to claim 1 wherein said time difference determination comprises finding a largest cumulative adjust of any path to a data input to said test interval.

10. The method according to claim 1 wherein said time difference determination comprises determining whether any non-zero cumulative adjust occurs on any path to a data input to said test interval.

11. The method according to claim 1 wherein said time difference determination comprises computing a separate arrival time for each unique cumulative adjust values along any path to a data input of said test interval and said selection of a jitter value comprises selecting a separate jitter value for each of said unique cumulative adjust values.

12. The method of claim 1 wherein said time difference determination comprises computing a time difference value based on at least one worst arrival time at said test interval.

13. The method of claim 12 further comprising repeatedly computing time differences and jitter values for a plurality of arrival times at said test interval until a worst slack for said test interval has been computed.

14. A computer readable medium for storing instructions for carrying out the steps of correcting timing signals used in testing a circuit being analyzed comprising:
determining the time difference between two clock edges defining a test interval;
determining the number of time periods of the voltage controlled oscillator signal which occurs during said time difference; and
selecting a value of jitter which is dependent on the number of periods of said voltage controlled oscillator which occur during said time interval.

15. A computer readable medium for storing instructions according to claim 14, further comprising storing the steps for:
selecting from a table contained on said medium said value of jitter.

16. The computer readable medium for storing instructions according to claim 14 which stores a table identifying the amount of period jitter for each of said periods of said voltage controlled oscillator contained in said time interval.

17. A computer readable medium for storing instructions for carrying out the analysis of statically timed logic circuits, comprising the steps of:
determining a period of a voltage controlled oscillator of a PLL which supplies a clock signal to said analyzed circuit design;
during a static test of said logic circuit, supplying a launching clock signal to a launching storage element whereby data is produced at an output, and a clocking signal to a capture storage element whereby data from said launching storage element is captured by a capture storage element;
determining whether one of said clock signals should be adjusted to establish a specific time interval between said clock signals;
adjusting said time interval;
determining from said adjusted time interval the number of clock periods of said voltage controlled oscillator within said time interval;
selecting a value of jitter to be subtracted from said time interval based on said number of clock periods; and
combining said value of jitter from said time interval.

18. The computer readable medium for storing instructions for carrying out the analysis of statically timed circuits according to claim 17 wherein said step of determining whether said clock signals should be adjusted comprises determining if a setup test is being conducted or a hold test.

19. The computer readable medium for storing instructions for carrying out the analysis of statically timed circuits further comprises the steps of:
during a setup test, adjusting the time between said launching clock and aid capture clock; and
subtracting said value of jitter from said time between said launching clock signal and said capture clock signal.

20. The computer readable medium for storing instructions for carrying out the analysis of statically timed circuits according to claim 18 further comprises the steps of:
during a hold test, adjusting the time between launching clock signal and capture clock signal; and
adding said value of jitter from said adjusted time interval.
